(19) United States
(12) Patent Application Publication
(10) Pub. No.: US 2018/0207792 A1
(43) Pub. Date: Jul. 26, 2018

(54) HIGH-SPEED GANTRY SYSTEM HAVING A LINEAR DRIVE

(71) Applicant: Fibro Lapple Technology GmbH, Hassmersheim (DE)

(72) Inventors: Jörg MATTHEUS, Gelsenkirchen (DE); Thomas KOLLMAR, Hassmersheim (DE)

(21) Appl. No.: 15/746,134

(22) PCT Filed: May 25, 2016
(86) PCT No.: PCT/EP2016/061861

§ 371 Date: Jan. 19, 2018

(30) Foreign Application Priority Data
Jul. 22, 2015 (DE) 10 2015 111 859.9

(51) Int. Cl. B25J 5/02; B25J 9/02; B25J 9/00

(52) U.S. Cl. CPC B25J 5/02; Y10S 901/16; B25J 9/0012; B25J 9/026

(57) ABSTRACT

A cross carriage for a gantry system for moving workpieces, loads and the like, formed of several construction plates arranged in adjacent parallel planes. Longitudinally and/or transversely extending hollow profiled elements are arranged between at least two of the construction plates and several or all of the construction plates and/or hollow profiled elements are predominantly formed of a plastic material, preferably a carbon fiber-reinforced plastic material.

### CROSS REFERENCE TO RELATED APPLICATIONS

This application is a U.S. National Phase Application under 35 U.S.C. 371 of International Application No. PCT/EP2016/061861 filed on May 25, 2016 and published in German as WO 2017/012756 A1 on Jan. 26, 2017. This application claims priority to German Application No. 10 2015 111 859.9 filed on Jul. 22, 2015. The entire disclosures of all of the above applications are incorporated herein by reference.

### FIELD

The disclosure relates to a cross carriage for a gantry system for moving workpieces, loads and the like at high speed, and to a corresponding gantry system which is equipped with a cross carriage.

### BACKGROUND

Two-axis gantry systems with cross carriages are already known in the prior art. Such gantry systems are used for guiding and driving a cross carriage which is provided with a Z axis. The drives known in the prior art operate electrically or pneumatically, as selected. Typically, the cross carriages are mounted so that they can be moved back and forth in a movement direction between end abutments along, for example, a rack. For reasons pertaining to intrinsic and dimensional stability, known cross carriages typically consist of a stable and therefore heavy metal construction and accordingly have high inertial masses, which can entail disadvantages during operation.

Possibilities of using such gantry systems exist wherever movements have to be performed relatively rapidly and precisely, such as, for example, in handling apparatuses, machine feeding devices, assembly installations, warehouse loading devices, automatic palletizing machines, stacker cranes, gantry loaders, modular robots as well as special-task positioning systems.

In the case of increasing size of the gantry systems and, in particular, in systems wherein large distances have to be covered (for example, of 10 meters and more) and for moving heavy masses, numerous technical problems arise. By means of the heavy construction solutions known in the prior art, heavy masses of the movable parts cannot be accelerated sufficiently quickly, in particular straight away, and moved and stopped again with the corresponding accuracy.

It is desirable, also in large gantry systems, such as hall gantry systems in production halls, to increase the speed of operation of the tools.

The known large-size gantry systems (i.e., systems having dimensions of several meters and more) do not allow, for example, speeds of approximately 10 m/s with a high acceleration of more than 20 m/s² (preferably 26 m/s²). Known drive systems of such gantry systems represent another limiting factor.

The underlying aim of the disclosure therefore is to overcome the above-mentioned disadvantages and to provide an improved gantry system as well as an improved cross carriage which can be moved at high speed and with high acceleration.

### SUMMARY

A first basic idea of the disclosure consists in the structural implementation of a lightweight plate construction of a cross carriage. For this purpose, it is provided according to the disclosure to form a cross carriage for a gantry system for moving workpieces, loads and the like, out of several construction plates arranged in adjacent parallel planes, wherein longitudinally and/or transversely extending hollow profiled elements are arranged between at least two of the adjacent construction plates and wherein, preferably, several or all the construction plates and/or hollow profiled elements are predominantly formed of a plastic material, preferably a carbon fiber-reinforced material.

In a particularly preferred design of the disclosure, the construction plates are preferably almost entirely to entirely made of a plastic material, preferably a fiber-reinforced plastic material such as, for example, carbon fiber-reinforced plastic material. A design that is only partially made of plastic is less preferable but also conceivable. In this context, “entirely” to “almost entirely” should be understood to mean that the structural properties such as shape, strength, deformability and inherent stability are determined predominantly to entirely by the plastic material and the additives or fillers thereof. Therefore, a structural design that is particularly advantageous is one in which it is possible to make do at least partially or preferably entirely without heavy metal constructions and metallic components and connection elements.

On the other hand, it is provided according to the disclosure to provide an electric linear drive both for the horizontal movement (X axis) and for the vertical movement (Z axis), wherein the primary plates of the linear drive are provided in mutually orthogonal orientation in each case on opposite outer sides of the cross carriage, or on or between the external construction plates.

With the inventive solution, transverse forces arising due to the linear drive (as a result of the attraction forces) can also be absorbed nearly completely, so that sagging of the cross carriage or of the construction plates that are part of the construction packet is practically ruled out. Even in the case of large-size dimensions (such as, for example, a plate length and/or plate width of approximately 1 m), a sagging of the cross carriage of less than 0.05 mm in transverse direction can be achieved.

Furthermore, in a preferred design of the disclosure, it is provided that two or more construction plates arranged in parallel planes are connected mechanically to one another with a defined spacing using a large number of spacer sleeves. For this purpose, preferably single-part or multi-part spacer sleeves and/or bushings are used, wherein, moreover, preferably one or all of the connection parts of the sleeves and bushings are formed of a plastic material such as, for example, a fiber-reinforced plastic material. Alternatively, metal sleeves can also be provided or a mixed fixture can be attached.

Advantageously, it is provided for this purpose that the spacer sleeves or bushings are designed for fixing the position of the construction plates in the parallel planes by means of plate holding means. For this purpose, the spacer sleeves and/or bushings are provided, for example, with grooves, steps, supports or collars as abutment and bearing support.

Moreover, it is also advantageous if at least two of the construction plates arranged in each case in parallel planes have an approximately identical length L in the direction of a first, preferably horizontal movement axis X of the gantry system and moreover preferably an approximately identical height H in the direction of a second vertical movement axis Z of the gantry system or define a corresponding envelope contour of a cuboid with identical edge length in the X and Z direction.

In a particularly preferred embodiment of the disclosure, the construction plates are arranged in three parallel planes. A respective front and rear plane is defined by an outer construction plate, while a third (central) plane is defined by a construction plate located in between. Each construction plate can be formed of two plate parts divided in the center or of several partial plate elements defining a surface.

In each case, profiled elements, preferably hollow profiled elements, are embedded between two construction plates arranged in adjacent parallel planes. Preferably, the profiled elements are introduced in the areas of force application points.

Moreover, it is advantageously provided that one or more shock absorbers protruding on the front side are arranged in each case in the movement direction of the cross carriage and are intended, in particular, to protect the cross carriage from major damage in the case of collision with other components. In addition, in each case a safety shock absorber is arranged on the end of the gantry system in order to ensure that the damage can be reduced in the case of collision on the respective path end of the horizontally extending X axis of the gantry system. Since the cross carriage according to the disclosure also has a linear motor-driven (vertical) Z axis capable of up and down movement, shock absorbers are thus also arranged on the front side above and below on the above-mentioned plate stack of the construction plates and thus along horizontally extending front sides of the construction plates.

Furthermore, in a preferred embodiment of the disclosure, it is provided that the cross carriage comprises a vertically oriented adapter plate attached substantially over the height of the cross carriage, for mounting a linear drive (for example, a primary portion of a linear drive) in the direction of a preferably vertical movement axis Z of the gantry system. The adapter plate is preferably formed of a satisfactorily heat-conductive material, preferably aluminum or a light metal alloy.

In addition, it can advantageously be provided that the cross carriage comprises an additional adapter plate attached horizontally substantially over the length of the cross carriage, for mounting an additional linear drive (or a primary portion of a linear drive) in the direction of a preferably horizontal movement axis X of the gantry system. The secondary portions of the linear drive, which work in collaboration with the primary portions of the linear drive, are arranged accordingly along the X or Z axis.

Another aspect of the present disclosure concerns, in addition to the above-mentioned passive cooling of the linear motor, the active cooling with an inventive cooling device for the linear motor. For this purpose, the cross carriage can be designed so that one or more air supply channels are provided for the cooling of linear drives mounted on the cross carriage or of parts thereof, channels which in each case comprise, on a channel end, at least one air inlet opening which is oriented in or opposite the horizontal direction of the cross carriage and of which the other open channel end is directed towards a position on the cross carriage that is designed as intended for mounting a linear drive part. Moreover, it is preferable if in each case an upper and a lower cooling channel corresponding to each movement direction are provided.

Moreover, according to the disclosure, a gantry system with a cross carriage as described above is provided, comprising a column system consisting of at least one column on which a longitudinal profiled guide element is fastened, which forms a horizontal movement axis X along which the cross carriage can be moved back and forth.

In another preferred embodiment of the disclosure, it is provided that the gantry system is designed for moving the cross carriage by means of at least one linear drive.

Moreover, it is provided advantageously to attach the rollers to the cross carriage via carbon fiber-reinforced bushings or plastic bushings on laterally overhanging bushing plates.

In another preferred embodiment of the disclosure, it is provided that several guide carriages are provided on the cross carriage, on which an arm is mounted, which can be moved up and down in the vertical direction Z.

Other advantageous embodiments of the invention are represented in further detail below together with the description of the preferred design of the disclosure in reference to the figures.

### DRAWINGS

FIG. 1 shows a perspective side view of an embodiment example of a gantry system;

FIG. 2 shows a cross-sectional view through the gantry system of FIG. 1 along the axis A-A,

FIG. 3 shows a perspective view of a portion of a cross carriage;

FIG. 4 shows a view from the side and from above of the represented portion of the cross carriage from FIG. 3,

FIG. 5 shows a partial perspective view of FIG. 3 shown in “transparent representation,”

FIG. 6 shows another “partially transparent” perspective view of a portion of the cross carriage;

FIG. 7 shows a rearward perspective view of FIG. 6, and

FIG. 8 shows a cross-sectional view through a fastening bushing.

### DESCRIPTION

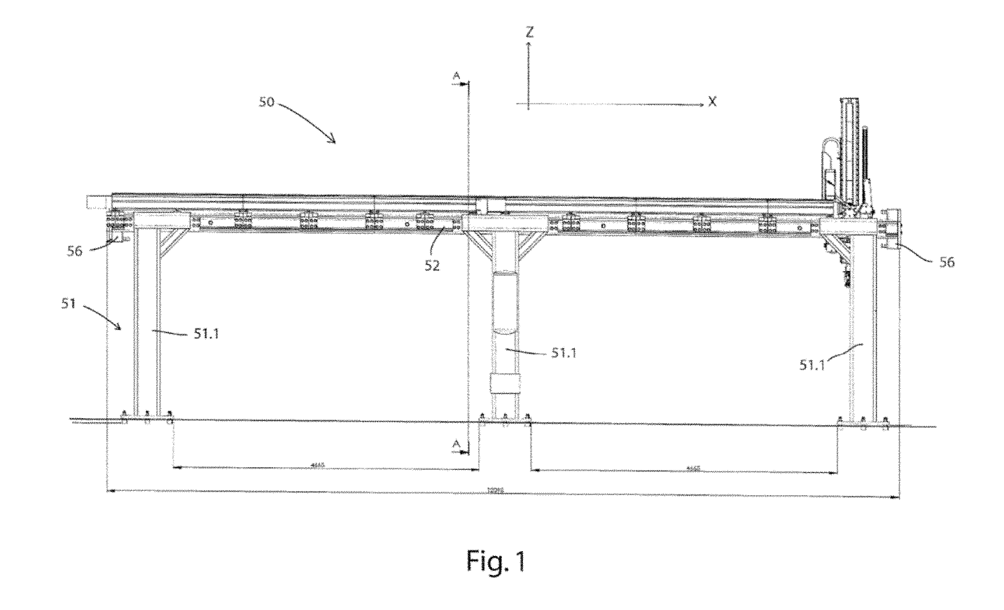

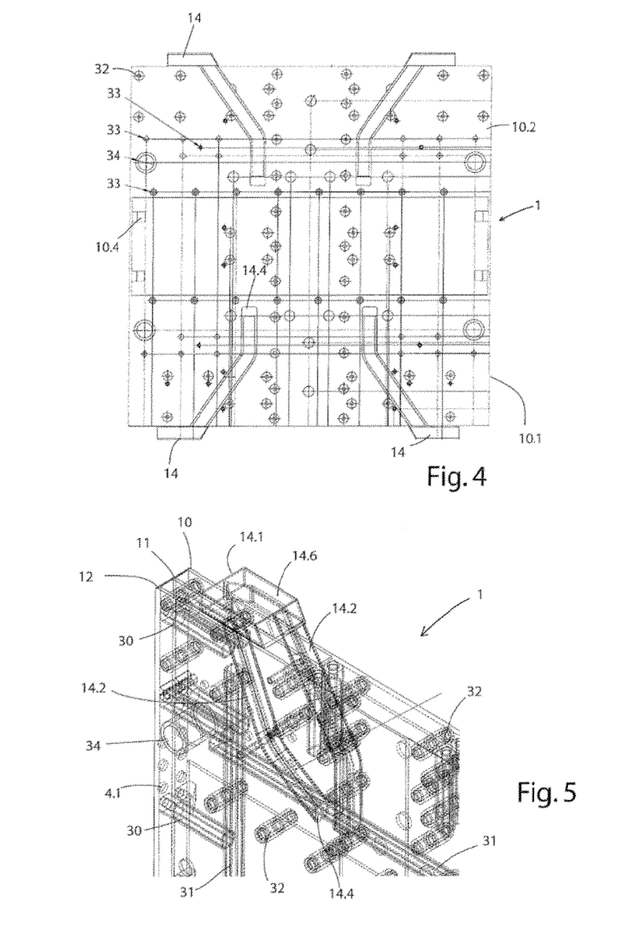

Below, the disclosure is explained in further detail in reference to FIGS. 1 to 8, wherein identical reference numerals refer to identical functional and/or structural features.

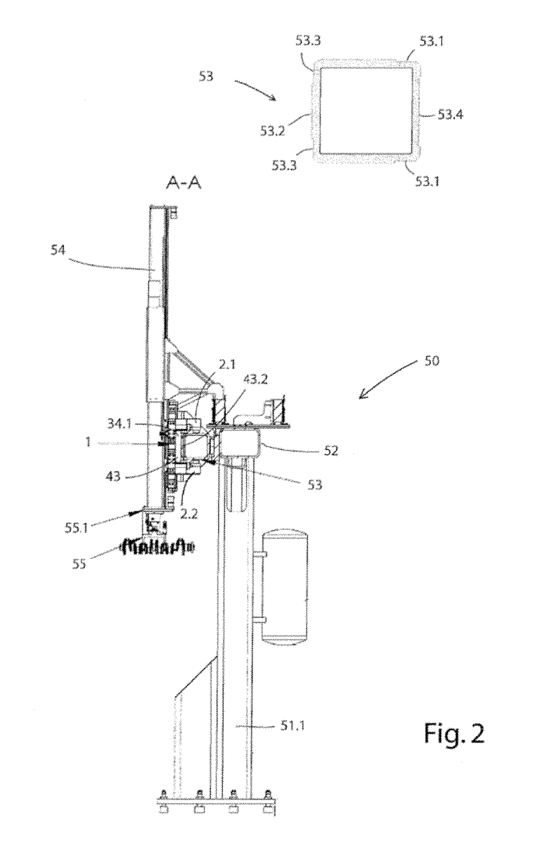

In FIG. 1, an exemplary side view of an embodiment example of an inventive gantry system 50 is shown, and in FIG. 2 a representation along the section axis A-A of FIG. 1 is shown. In the present embodiment example, the gantry system 50 has an extent in the x direction of approximately 12 m. The gantry system 50 comprises a column system 51 consisting of three columns 51.1. A hollow profiled element 52 extends along the columns 51.1 in the x direction. On the hollow profiled element 52, a profiled guide element 53 is in turn arranged, of which the geometric design is shown in detail (in a mirrored view) in the detail view of FIG. 2.

On a vertically extending profile wall of the profiled guide element 53, the connection 53.2 for the column 51.1 is shown. Furthermore, steps 53.3 (respectively at the top and at the bottom) are provided at the connection 53.2 of the profiled guide element 53. Respectively on the upper and the lower side of the profiled guide element, milled grooves 53.1 are located, for guiding the cross carriage 1 to be described later. On the front side of the profiled guide element 53 opposite the connection 53.2, a milled groove 53.4 for a secondary portion of the linear motor 43 mounted along the x axis of the gantry system 50, is located.

Furthermore, one can see in FIG. 2 that the cross carriage 1 comprises an arm 54 which can be moved up and down in the z direction of the gantry system 50, and on the front-side lower end 55.1 of which an exemplary tool 55 is represented. The arm 54 can be moved up and down via a linear motor 43 oriented in the vertical direction. The cross carriage 1 comprises an upper and a lower roller block 2.1 or respectively 2.2, on which the rollers 2.3 of the cross carriage 1 are fastened. The cross carriage 1, driven by a first linear motor 43, can be moved back and forth from a respective first end-side abutment along the x axis toward an opposite end-side abutment of the gantry system 50, while, at the same time, the arm 54 can be moved up and down by a second linear drive. On the end side, on the gantry system 50, safety shock absorbers 56 are provided in each case on the abutments.

Furthermore, as an example, in FIG. 2, the primary plates 43.1 and the secondary plates 43.2 of the linear motor 43 are indicated.

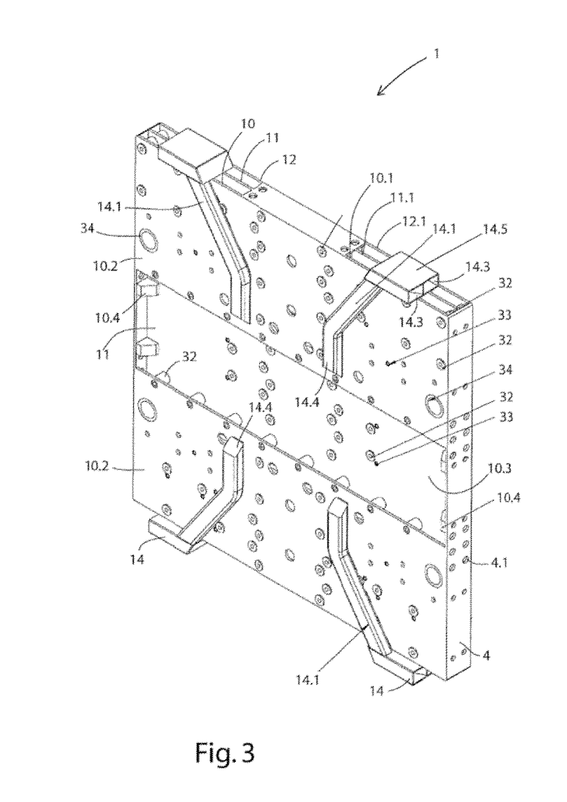

In FIGS. 3 to 7, an embodiment example of an inventive cross carriage 1 is described in further detail. FIG. 3 shows a perspective view of a portion of a cross carriage 1. The cross carriage 1 is constructed as a plate stack of construction plates 10, 11, 12 arranged in three adjacent parallel planes.

The construction plates 10, 11, 12 form in each case front side edges 10.1, 11.1, 12.1 on the outer periphery of the cross carriage 1, which are partially closed with a side wall 4.

The front external construction plate 10 shown in FIG. 3 is formed of two plate portions 10.2. Between the two plate portions 10.2 of the construction plate 10, a partially open area with a view onto the central construction plate 11 is located. The recess 10.3 shown is used for receiving a secondary portion 43.1 of a linear motor 43 for the drive in the X direction. For supporting an adapter plate 40 which cools the linear motor 43, support blocks 10.4 are attached in each case on the edge side to the cross carriage 1.

In each case hollow profiled elements 30, 31 extending longitudinally and transversely in the interstices are arranged between the construction plates 10 and 11 and between the construction plates 11 and 12. To make the hollow profiled elements 30, 31 visible, the cross carriage 1 is shown in a “partially transparent” representation in FIGS. 5 to 7, wherein the external construction plate is represented as “transparent” in order to make the interior of the cross carriage 1 visible.

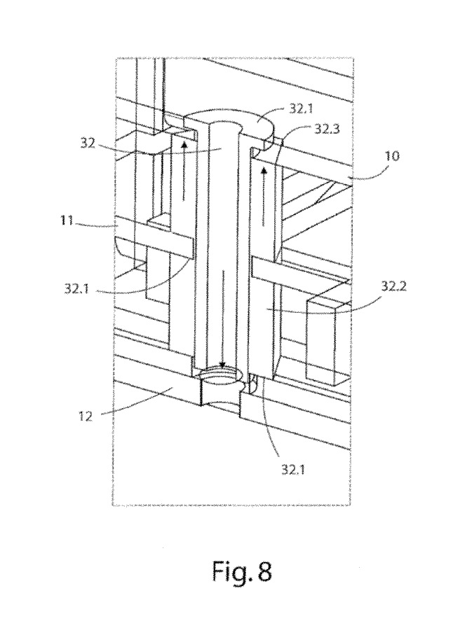

As can also be seen in FIG. 3, a side wall plate 4 is located on the front side in and opposite the x direction along the front side edges 10.1, 11.1, 12.1 of the construction plates 10, 11, 12, in which a plurality of openings 4.1 are provided for fastening cross carriage components. Furthermore, different sleeve types 32, 33, 34 are represented in FIGS. 3 to 7, which have been used according to the disclosure in order to achieve, on the one hand, a selected plate stack construction, and, on the other hand, to be able to fasten add-on parts to the cross carriage. The parallel planes are obtained by using a large number of spacer sleeves. On the spacer sleeves 32, 33, plate holding means 32.1 are provided, as shown diagrammatically in FIG. 8.

The spacer sleeves 32, 33 or bushings are used for fixing the position of the construction plates 10, 11, 12 in the parallel planes by means of the plate holding means 32.1 which are here formed as grooves and steps or supports and collars, as also shown diagrammatically in FIG. 8 by the representation of the edge lines.

Furthermore, adapter sleeves 34 for fastening add-on parts to the cross carriage 1 are provided.

In the present embodiment example, the rear construction plate 12 in FIG. 1 also comprises a recess similar to the recess 10.3 but in the vertical direction. Said recess is produced approximately in the center between the represented air supply channels 14.1. This recess is also used for receiving a primary portion 43.1 of a linear drive 43 together with an adapter plate 40 provided for passive cooling.

Another aspect of the present disclosure concerns, in addition to the passive cooling by the adapter plates 40, an active cooling with a cooling device 14.

In the present embodiment, the cooling device 14 is formed by air supply channels 14.1, 14.2 which are arranged on respective opposite outer sides of the cross carriage 1 and are associated with the respective direct drive 43 arranged there. For each channel 14.1 and 14.2, an air inlet opening 14.3 is provided. The air inlet opening 14.3 is provided by an air connector 14.5. In the present embodiment, in each case two air supply channels 14.1 and 14.2 are connected to a common air connector 14.5, wherein the air connector in each case comprises a left-side and a right-side air inlet opening 14.3 and thus acts like a Y distributor. For each air inlet opening 14.3, an air stream is guided towards the open channel end 14.4 in each case via the associated air supply channel 14.1 or 14.2. The open channel end 14.4 is oriented in a position on the cross carriage 1 in the direction of the linear drive 43 provided there.

As one can also see clearly in FIG. 5, for the two movement directions of the cross carriage (X direction and Z direction), in each case in said direction and in the opposite direction, an air connector 14.5 with associated air supply channels 14.1 and 14.2 is provided, so that, depending on the movement direction, in each case an air stream is guided through the air inlet openings 14.3 towards the linear drives 43, and the linear drives are accordingly cooled.

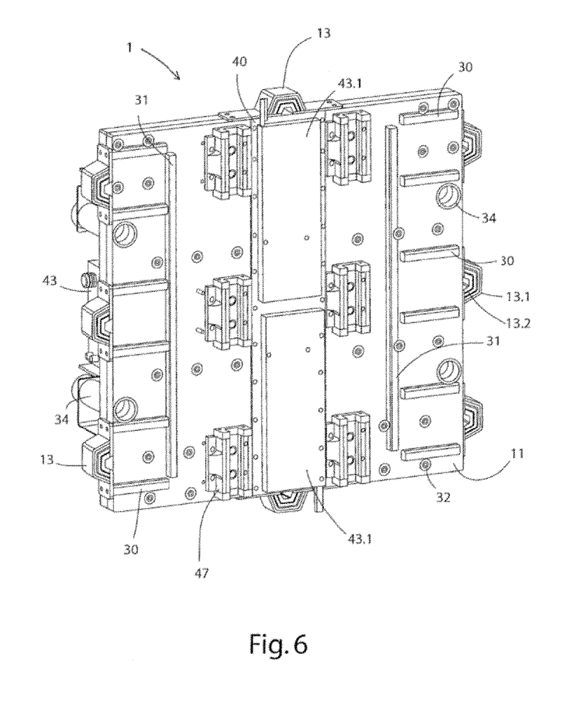

FIG. 6 shows another diagrammatic view in the form of an also “partially open” perspective view of a portion of the cross carriage 1. Furthermore, in this representation, several shock absorbers 13 are shown. These shock absorbers 13 protrude in each case from the front side edges 10.1, 11.1, 12.1 of the construction plates in the x or z movement direction from the front sides of the cross carriage 1. The shock absorbers 13 are formed by multiple absorber plates 13.1 mounted one on top of the other with spacing, wherein, in the present embodiment example, an additional absorber material 13.2 is moreover introduced between the absorber plates 13.1. The absorber material 13.2 is preferably an energy-consuming absorber material. Thus, for example, a plastically deformable material can be introduced between the absorber plates 13.1. It is also conceivable to introduce an only elastically deformable material as absorber material 13.2 or a combination of the above mentioned materials. Furthermore, as can be seen in FIG. 6, guide carriages 47 are provided on the cross carriage 1, which are used for the rail guide for the z axis.

In the x direction, in each case on the left and on the right of the front side edges of the cross carriage 1, three shock absorbers 13 are arranged, while in the z direction in each case a upward and downward oriented shock absorber 13 is provided. As can also be seen, behind the fastening points 13.3 of the shock absorber 13, in each case horizontally arranged hollow profiled elements 30 are located, which, together with the construction plates 10, 11, 12, determine the strength and stiffness of the cross carriage 1.

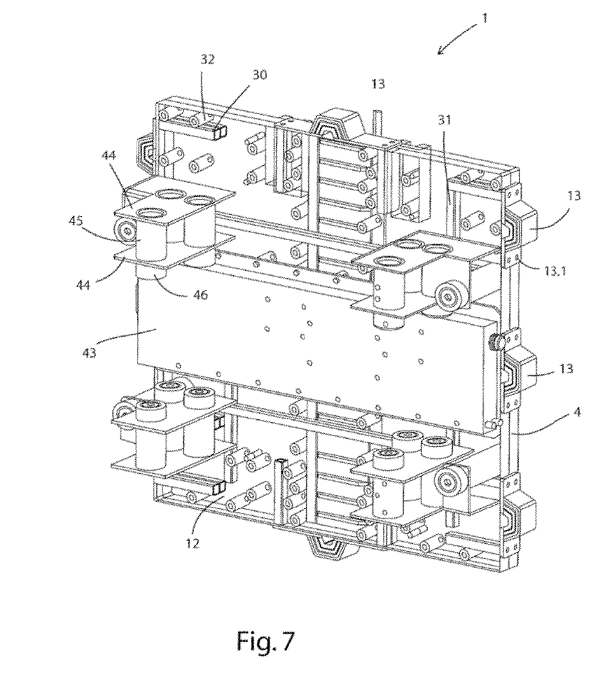

In FIG. 7, a rearward, also partially-open view of the representation of the cross carriage 1 from FIG. 6 is represented. Between two holding plates 44, bushings 45 with rollers 46 are fastened.

In FIG. 8, an exemplary fastening bushing 32 is shown. By means of a screw, a tensile force is introduced into the cross carriage 1 on the lower side. Via the flange 32.1, the force is transmitted into the surrounding plastic bushing 32.2, and a closed force flow is generated.

The plastic bushing 32.2 comprises a lower abutment 32.1, against which the lower construction plate 12 can be braced. The central construction plate 11 engages in groove-shaped recesses 32.1 of the surrounding plastic bushing 32.2. The plastic bushing 32.2 can advantageously be designed as a bushing with anti-rotation means 32.3. As anti-rotation means 32.3, a hexagonal design is provided here, which engages in corresponding recesses in at least one construction plate 10, 11, 12.

The disclosure, in terms of its design, is not limited to the above-indicated preferred embodiment examples. Instead, a number of variants are conceivable, which make use of the represented solution, even in designs of fundamentally different type.

1. A cross carriage for a gantry system for moving workpieces, loads and the like, of the cross carriage comprising
a. a plurality of construction plates arranged in adjacent parallel planes, wherein
b. longitudinally and/or transversely extending hollow profiled elements are arranged between at least two of the construction plates and
c. wherein at least one of the construction plates and/or hollow profiled elements are predominantly formed of a plastic material, preferably a carbon fiber-reinforced material.

2. The cross carriage according to claim 1, wherein the construction plates consist almost entirely of a plastic material, preferably a fiber-reinforced plastic material.

3. The cross carriage according to claim 1, wherein two or more of the construction plates arranged in parallel planes are mechanically connected to one another using of spacer sleeves.

4. The cross carriage according to claim 3, wherein the spacer sleeves are designed for connecting construction plates arranged in parallel planes to plate holding means or spacer means.

5. The cross carriage according to claim 1, wherein at least two of the construction plates arranged in each case in parallel planes have an approximately identical length L in a direction of a first, preferably horizontal movement axis of the gantry system and moreover preferably an approximately identical height H in a direction of a second vertical movement axis of the gantry system.

6. The cross carriage according to claim 1, wherein one or more protruding shock absorbers are arranged along vertically and/or horizontally extending front sides of the construction plates.

7. The cross carriage according to claim 1, wherein the cross carriage furthermore comprises a vertically oriented adapter plate attached substantially over a height of the cross carriage, for mounting a linear drive in a direction of a preferably vertical movement axis of the gantry system.

8. The cross carriage according to claim 1, wherein the cross carriage furthermore comprises an adapter plate attached horizontally substantially over a length of the cross carriage, for mounting a linear drive in a direction of a preferably horizontal movement axis of the gantry system.

9. The cross carriage according to claim 1, wherein the cross carriage is formed with an active cooling device.

10. The cross carriage according to claim 1, wherein one or more air supply channels are provided for cooling of linear drives mounted on the cross carriage, the supply channels comprising, on a first channel end, at least one air injection opening which is oriented in or opposite the horizontal direction of the cross carriage and of which a second channel end is directed towards a position on the cross carriage that is designed as intended for mounting a linear drive part.

11. The gantry system with the cross carriage according to claim 1, comprising a column system on which a longitudinal profiled guide element is fastened, which forms a horizontal movement axis along which the cross carriage can be moved back and forth.

12. The gantry system according to claim 11, wherein the gantry system is designed for moving the cross carriage by means of at least one linear drive, for each movement direction.
